(19) United States
(12) Patent Application Publication
(10) Pub. No.: US 2026/0121950 A1
(43) Pub. Date: Apr. 30, 2026

(54) DETERMINING SIGNAL CHARACTERISTICS AND TRANSMISSION ANOMALIES IN TELECOMMUNICATION SYSTEMS

(71) Applicant: VIAVI SOLUTIONS INC., Chandler, AZ (US)

(72) Inventors: Jong-Min KIM, Seoul (KR); Young-Kill Kim, Gyeonggi-do (KR); Yoo-Chul Shin, Seoul (KR)

(73) Assignee: VIAVI SOLUTIONS INC., Chandler, AZ (US)

(21) Appl. No.: 18/925,627

(22) Filed: Oct. 24, 2024

(51) Int. Cl. H04L 43/045; H04L 43/02; H04L 43/0823; H04L 43/12

(52) U.S. Cl. CPC H04L 43/045; H04L 43/02; H04L 43/0823; H04L 43/12

(57) ABSTRACT

A modular testing device provides field technicians with resources to support multiple aspects of signal analysis. The modular testing device includes multiple modules such as a base module, a user interface module, a testing module, and a battery module. The modular testing device may include a processor, a memory to store machine readable instructions executable by the processor to capture first data associated with signal activity of a communications link for a first capture period, capture second data associated with signal activity of the communications link for one or more additional capture periods, overlay a first representation of the first data and a second representation of the second data to display a overlay representation on a graphical user interface (GUI) of a display component, and denote at least one of one or more signal characteristics and anomalies in the graphical user interface.

### TECHNICAL FIELD

This patent application relates generally to testing of communication networks, and more specifically, to signal analysis techniques for determining signal characteristics and transmission anomalies in telecommunications systems.

### BACKGROUND

Data centers are centralized computer network systems that enable transfer of data and content (e.g., over the internet), and provide storage and backup of the data and content as well. This may include transfer between two data centers a few miles apart, or two data centers connected via trans-oceanic links.

Typically, a data center includes various communications equipment to support network communications. This equipment typically connects to wireline communications networks, which may be comprised of fiber optic cables and coaxial cables.

During operation of a data center, various issues may arise that may require servicing. These issues may include installation, preventative and remedial maintenance, testing and analyzing network communication, and testing network integrity and quality. With proper equipment and training, modern data centers may be serviced by a technician, and thereby reducing a need for an on-site engineer.

### BRIEF DESCRIPTION OF THE DRAWINGS

Features of the present disclosure are illustrated by way of examples shown in the following figures. In the following figures, like numerals indicate like elements, in which:

FIG. 1A illustrates a perspective view of a modular testing device including a base module and an input/output (I/O) device, according to examples of the present disclosure;

FIG. 1B illustrates a back side view of a base module, according to examples of the present disclosure;

FIG. 1C illustrates a top view of a base module, according to examples of the present disclosure;

FIG. 1D illustrates a bottom view of a base module, according to examples of the present disclosure;

FIG. 1E illustrates an exploded perspective view of a modular testing device including an I/O device, a base module, and dual expansion modules, according to examples of the present disclosure;

FIG. 1F illustrates an exploded perspective view of a modular testing device including a removably connected module, according to examples of the present disclosure;

FIG. 2 illustrates a test process automation workflow, according to examples of the present disclosure;

FIG. 3A illustrates a high level system diagram of test process automation, according to examples of the present disclosure;

FIG. 3B illustrates a graphical user interface (GUI) for a modular testing device having an automated test plan, according to examples of the present disclosure;

FIG. 4A illustrates a modular testing device operable to detect interference in a cellular service provider, according to examples of the present disclosure;

FIG. 4B is a block diagram of the modular testing device, according to an example of the present disclosure;

FIGS. 5A-5C illustrate various aspects of radio frequency (RF) signal analysis, according to examples of the present disclosure;

FIGS. 6A-6D illustrate various aspects of radio frequency (RF) signal analysis via accumulation, according to examples of the present disclosure;

FIG. 7 illustrates a block diagram of a system that may be implemented to use signal analysis techniques for determining signal characteristics and transmission anomalies in telecommunications systems, according to examples of the present disclosure;

FIG. 8 illustrates a method for using signal analysis techniques for determining signal characteristics and transmission anomalies in telecommunications systems, according to examples of the present disclosure.

### DETAILED DESCRIPTION

For simplicity and illustrative purposes, the present disclosure is described by referring mainly to examples thereof. In the following description, details are set forth in order to provide an understanding of the present disclosure. It will be readily apparent however, that the present disclosure may be practiced without limitation to these details. In other instances, some methods and structures have not been described in detail so as not to unnecessarily obscure the present disclosure.

Throughout the present disclosure, the terms “a” and “an” are intended to de at least one of a particular element. As used herein, the term “includes” means includes but not limited to, the term “including” means including but not limited to. The term “based on”means based at least in part on.

Data centers enable sharing of data and content and provide storage and backup for redundancy, and typically house compute and storage resources for applications, data, and content. A data center typically includes various electronic equipment to support network communication(s).

The electronic equipment of a data center generally connects to wireline networks, which may be comprised of fiber optic cables and coaxial cables. The sharing may take place between two data centers a few miles apart, or two data centers connected via trans-oceanic lines.

One technology that may be utilized to enable sharing across data centers is Data Center Interconnection (DCI) technology. DCI may be utilized to implement high-speed data packet transfer for two or more data centers over various distances.

It may be appreciated that data center operations may depend on a wide range of design and logistical variables. Examples of these variables may include, among others, a location of the data center(s), distance between data centers, bandwidth, cost, and capacities of local service providers.

In some instances, these complexities may require the expertise of one or more on-site engineers. However, this may significantly increase operational costs of a data center. With proper equipment and training, data centers may instead be serviced by a technician, and thereby reducing a need for an on-site engineer. With proper equipment, a technician may be able to troubleshoot and optimize a large number of the issues that may arise during data center operations.

A data center installation, testing, measurement, and maintenance device, referred to herein as a modular testing device or testing device, provides a configurable, multi-protocol testing system for telecommunication systems. For example, the modular testing device described herein provides field technicians with resources to support multiple aspects of data center testing, including testing for installation and maintenance of data centers, and testing related to, and not limited to, network devices, fiber optic cables and optical signals, coaxial cables and antennas.

The modular testing device as described provides multiple technical advantages over existing devices. The modular testing device delivers improved efficiencies as it may replace multiple independent devices that may typically be required for testing scenarios, and provide additional measurements and insights that can improve installation and maintenance of data centers.

As described in further detail below, the modular testing device is modular, in that different modules may be added to the modular testing device to facilitate different types of testing. A module may be, among other things, a software or hardware element, or a combination of hardware and software elements that may be utilized in conjunction with the modular testing device (as further described below). Thus, the modular testing device is scalable, because modules can be added to the modular testing device to accommodate new testing requirements and scenarios. In addition, the modular testing device may be mounted on a variety of data center devices, such as a server rack (i.e., it may be “rack-mountable”).

Also, as described in further detail below, the modular testing device may include job manager software that enables automated testing to be performed. A job may comprise one or more tests to be performed by the modular testing device in a specified sequence. One or more jobs may be created and stored in the modular testing device for different tasks. Jobs, including workflows for testing, can be defined centrally and downloaded to modular testing devices at multiple data centers, eliminating the variability of manual procedures and thereby driving consistent, repeatable results, regardless of technician skill or experience level.

The modular testing device permits data center technicians to test, among other things, fiber, radio frequency (RF), Spectrum Analysis (SA), Common Public Radio Interface (CPRI), and Ethernet from a single instrument, replacing multiple independent devices. Examples of other tests the modular testing device may perform include system development, Ethernet traffic load, transponder hardware validation, BER testing, FEC compliance and validation, and interconnect (IC) development and validation. In an example, and as will be described in further detail below, the modular testing device includes modules that provide the ability to test specific protocols all in one device.

By implementing use of a modular testing device as described, training for technicians shifts to learning of the test process itself, which is faster and easier to learn, rather than on analysis of technical information, which is generally time-consuming and overwhelming for new technicians. Furthermore, the job manager software can eliminate wasted technician time regarding trying to remember which tests to run and how to run them. The above-described technical advantages and other technical advantages are further described below.

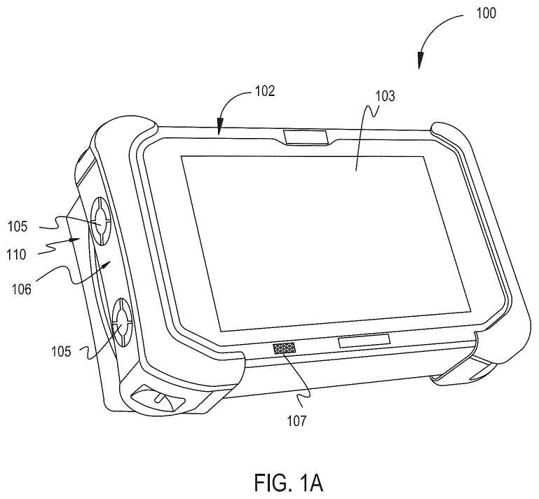

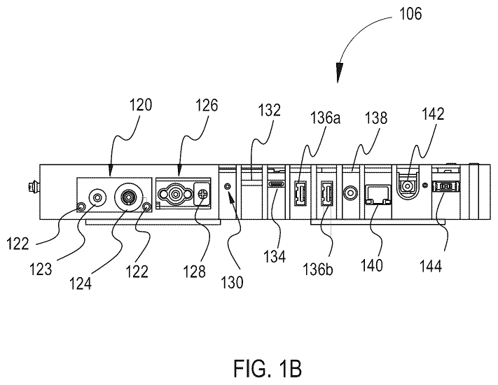

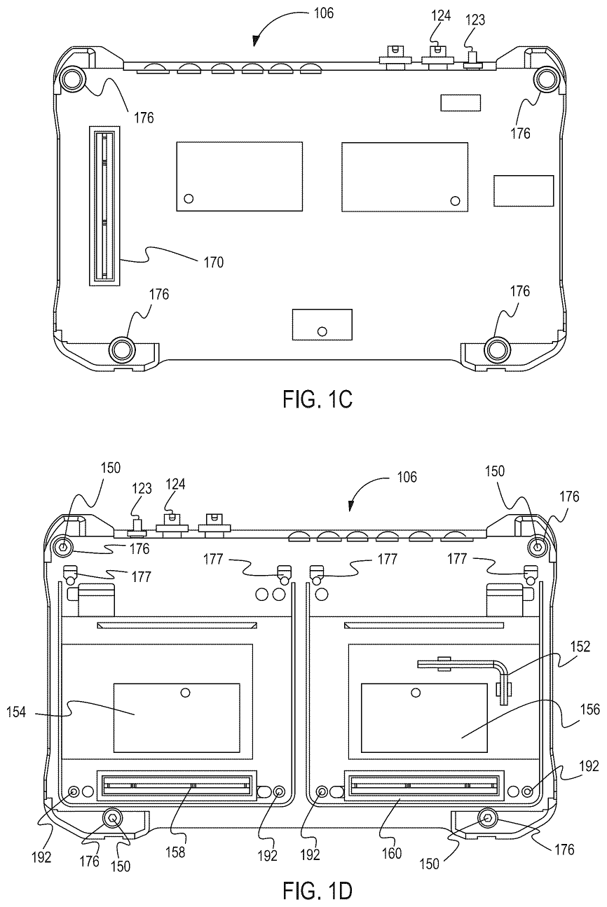

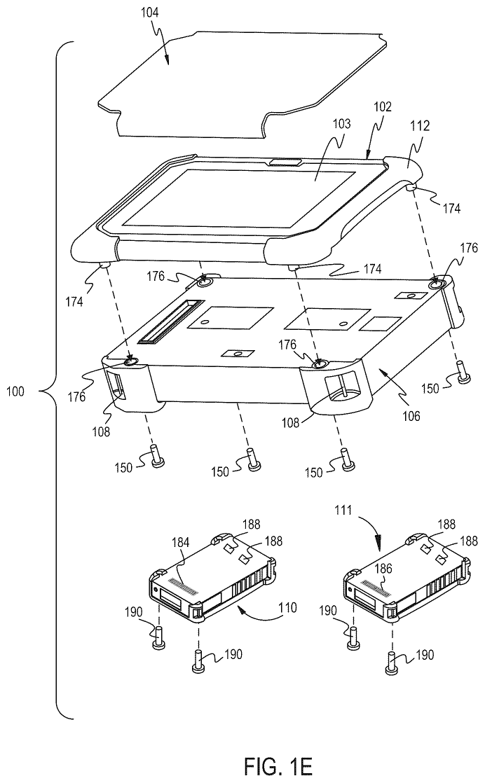

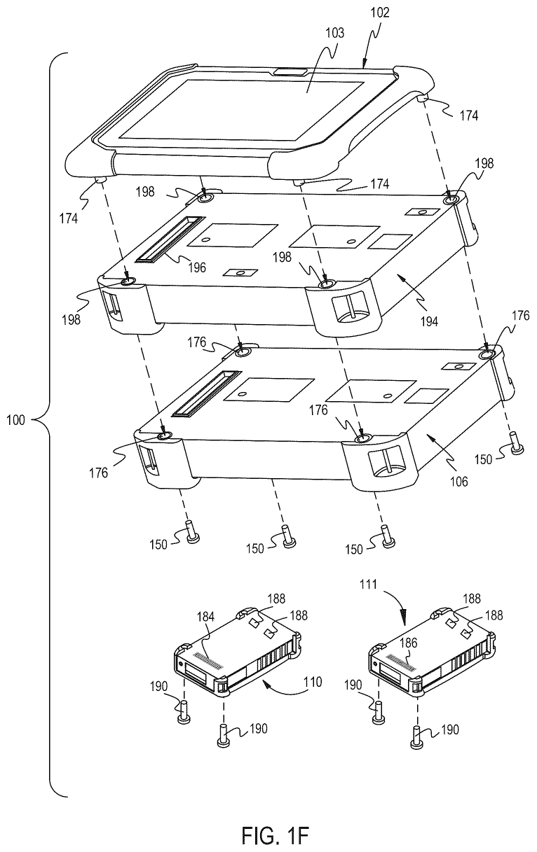

FIG. 1A illustrates a perspective view of a modular testing device 100 including base module 106 and I/O device 102 (which may be removably connected), according to examples of the present disclosure. Modular testing device 100 may be a modular hand-held device comprising removably connectable field replaceable modules for data center installation, testing, measurement, and maintenance. According to an example, modular testing device 100 includes (removably connectable) I/O device 102, and a (removably connectable) base module 106.

According to an example, I/O device 102 includes a display 103 that provides user control and information. According to an example, the display 103 may be a touch screen, e.g., liquid crystal display (LCD) touchscreen. The modular testing device 100 provides user information including: a listing of jobs, a listing of reports to be compiled, a compilation of executed test results in a test report or test reports, and an interface control with a work station or server. Base module 106 provides hardware, software and firmware to control modular testing device 100.

According to the illustrated example of FIG. 1A, ventilation ports 105 are provided to the outer structure of base module 106 to facilitate internal cooling of components by way of an internal cooling unit. Loudspeaker 107 provides audio information. Base module 106 provides a structural base for modular testing device 100.

According to an example, modular testing device 100 may be configured in a variety of assemblies with a plurality of different removably connectable modules to support workflow and project specifications. According to the illustrated example of FIG. 1A, modular testing device 100 includes first expansion module 110 removably connected to the bottom of base module 106.

FIG. 1B illustrates a back side view of base module 106, according to an example. Base module 106, similar to other modules described herein, includes a plurality of modular elements used for data center installation, testing, measurement, and maintenance.

According to an example, base module 106 includes PM-DL module 120, also known as a power meter/datalink optical module. PM-DL module 120 and other modules described herein may be factory installed with base module 106 or one or more modules may be attached to base module 106 by a user. In an example, PM-DL module 120 is secured by way of connection members 122. PM-DL module 120 includes power meter port 123 and TS-PC port 124, also known as a Talkset-Datalink port. Power meter port 123 is used to determine optical power of a fiber under test. TS-PC port 124 is used to communicate voice or data with another device along an optical fiber.

According to an example, base module 106 also includes VFL module 126, also known as a Visual Fault Locator (VFL) module, to provide detection of a visual fault location. A VFL test uses brightly visible light to check patch cords for defects and verify continuity.

According to an example, base module 106 includes a number of additional inputs and control interfaces as follows. Reset button 130 provides a hard reset of modular testing device 100. Reset button 130 may be depressed with a small object, such as an extended paperclip. Micro-SD port 132 provides removable storage to modular testing device 100 by accepting a micro-SD card. The micro-SD card may provide memory for storing data center data, predetermined setup configurations, test results, and compiled reports. USB-C port 134 provides an interface to modular testing device 100 according to the USB-C standard. USB-C port 134 also provides a debug-serial-port to support testing and trouble-shooting of modular testing device 100. An audio interface, and/or headset may be multiplexed with USB-C port 134 by way of an external adapter, such as a USB-C or 3 mm adapter. A pair of USB-A Interfaces 136a and 136b provides support for connection of USB 2.0/3.0 peripherals, such as an external fiber microscope, set forth in greater detail below.

Audio jack 138 provides a direct audio interface by accepting a 3 mm male plug. Ethernet port 140 is RJ-45 jack to provide 10/100/1000-BaseT Ethernet management. On/Off switch 142 is configured to turn modular testing device 100 on and off. DC-input 144 is configured to receive DC power for modular testing device 100 from an external power supply. Although not illustrated in FIG. 1B, a mini USB port may also be provided. Base module 106 may also include a wireless network module to support wireless network communication and a Bluetooth module to support Bluetooth communication with an external device, such as a Bluetooth audio headset.

FIG. 1C illustrates a top view of base module 106, according to examples of the present disclosure. Base module 106 includes a plurality of through holes to mate with corresponding protrusions in the housing of I/O device 102. Base module 106 provides electrical power and communication to I/O device 102 or other modules, including solution modules and expansion modules, by way of base module backplane interface.

FIG. 1D illustrates a bottom view of base module 106, according to examples of the present disclosure. Base module 106 includes a plurality of through holes to receive a plurality of connection members 150 to (removably secure) base module 106 to I/O device 102. According to an example, connection device 152 is disposed within base module 106 to support field replacement of different removably connectable modules (attachable to a top side of base module 106). Base module 106 includes a plurality of access panels, such as access panels 154 and 156 to support factory installation of various internal modules, such as the wireless network module or Bluetooth module.

Base module 106 includes first expansion interface 158 and second expansion interface 160 to provide electrical communication and power to a plurality of different expansion modules. According to an example, the bottom of base module 106 includes recesses to receive corresponding cleats from expansion modules, such as cleats 188 shown in FIG. 1E of expansion modules 110 and 111. Threaded bushings 192 then receive structural members, which pass through holes in the expansion modules to be received therein.

FIG. 1E illustrates an exploded perspective view of modular testing device 100 including I/O device 102, base module 106, and expansion modules 110 and 111, according to examples of the present disclosure. An optional screen cover 104 may be removably attached to the housing of I/O device 102 to provide protection to display 103. Base module 106 is removably connected to I/O device 102 by a plurality of connection members 150. According to an example, I/O device 102 includes a plurality of protrusions that are configured to be received within through-holes defined by the structural housing of base module 106. According to an example, first expansion module 110 has structure a defining holes, and expansion module 111 has a structure defining holes. Connection members 190 pass through holes and are received within threaded bushings 192 of base module 106. Cleats 188 of expansion modules 110 and 111 are received within recesses in the bottom of base module 106. First expansion module 110 includes expansion interface 184 to communicate power and control signals with base module 106. Likewise, expansion module includes expansion interface to communicate power and control signals.

FIG. 1F illustrates an exploded perspective view of modular testing device 100 including a (removably connected) first solution module 194, according to examples of the present disclosure. Upon integration of first solution module 194, base module 106 provides electrical power and communication to first solution module 194 by base module backplane interface. Likewise, first solution module 194 provides electrical power and communication to I/O device 102 by way of top solution interface 196. First solution module 194 also includes a bottom solution interface (not shown) connectable to base module backplane interface, described in greater detail below. According to another example, a second solution module may be optionally disposed between first solution module 194 and base module 106. The base module backplane interface connects power and communication (e.g., carrying data) busses of the base module 106 to modules connected to the base module 106 via base module backplane interface or other interfaces.

First solution module 194 has a similar housing and form factor to base module 106 to provide integration between I/O device 102 and base module 106. First solution module 194 includes a plurality of through holes 198 to mate with corresponding protrusions in the housing of I/O device 102. First solution module 194 provides electrical power and communication to I/O device 102 by way of top solution interface 196. First solution module 194 is removably connected to I/O device 102 by connection members 150.

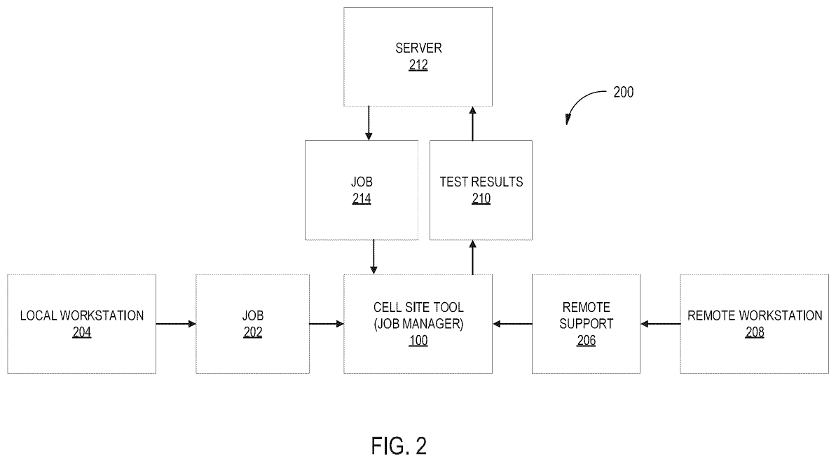

FIG. 2 illustrates test process automation workflow 200, according to examples of the present disclosure. A workstation, such as local workstation 204, creates a job, such as job 202, which may be loaded onto modular testing device 100. Alternatively, server 212 may load a job, such as job 214, onto modular testing device 100. Modular testing device 100 may receive remote support 206 from remote workstation 208.

Modular testing device 100 may deliver test results 210 to server 212. According to an example, modular testing device 100 may also deliver test results to local workstation 204 or remote workstation 208. Modular testing device 100 includes job manager software, known simply as job manager, which presents GUIs to manage jobs and execute tests. A job may include, among other things, a set of tests to be executed by modular testing device 100. The job manager can be used to define and customize jobs, and coordinates tasks and results across multiple testing devices and modules connected to modular testing device 100. The job manager displays step-by-step instructions to a user for executing tests with modular testing device 100. Job manager also displays progress and test results related to tests executed by modular testing device 100.

Modular testing device 100 supports communication with centralized management (CM) software running on server 212, which is presented to a user as a graphical user interface (GUI). The CM software organizes and pushes test configurations and job 214 to modular testing device 100. The CM software automatically collects and organizes tests results 210 executed by modular testing device 100. The CM software presents a GUI on server 212, including a server dashboard of Key Performance Indicators (KPIs).

Modular testing device 100 may receive remote support 206, including communication and control, by remote workstation 208. Remote workstation 208 provides remote access and control of modular testing device 100, and also supports file transfer.

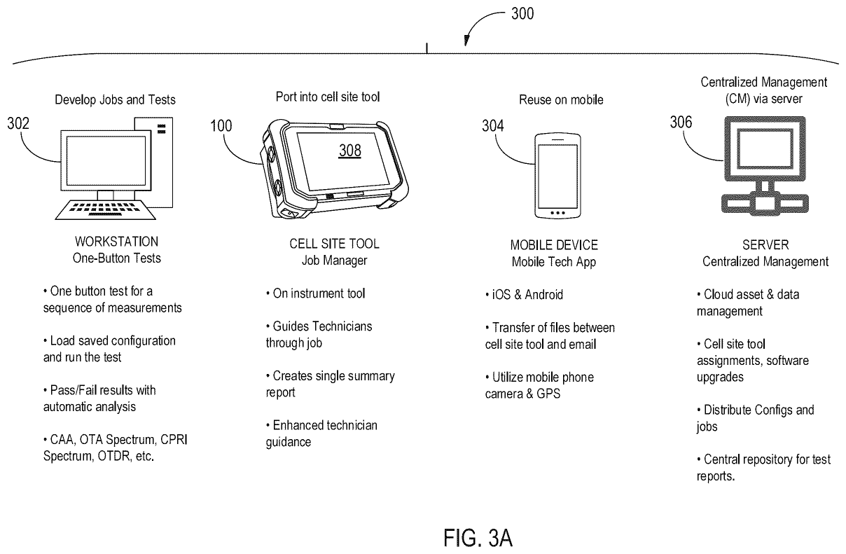

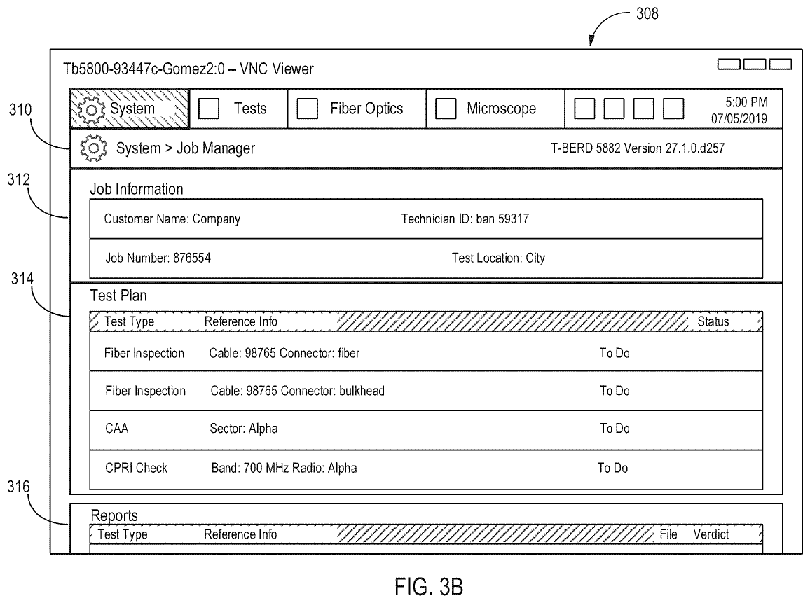

FIG. 3A illustrates a high level system diagram of test process automation 300, according to examples of the present disclosure. Test process automation 300 includes cooperation and communication between modular testing device 100, workstation 302, mobile device 304, and server 306. Workstation 302 is used to develop jobs, tests, and one-button tests. A one button test may be developed to execute a sequence of measurements by modular testing device 100. Workstation 302 may communicate with modular testing device 100 to load a saved configuration into modular testing device 100, and optionally control the modular testing device to run the test. Workstation 302 may develop a test with Pass/Fail results, and configure modular testing device 100 to perform automatic analysis.

Modular testing device 100 runs a job manager application, which may control the modular testing device 100 to perform the tests. The job manager application may guide technicians through a job, and create a single summary report corresponding to the executed job tests. According to an example, the job manager application also includes enhanced technician guidance, which may be selected by the technician to display step-by-step instructions on GUI 308 of modular testing device 100.

Mobile device 304 is a smart phone running an iOS or Android operating system and a mobile tech application. By using the mobile tech application on mobile device 304, a technician may communicate with server 306 and modular testing device 100 to transfer files such as a summary report corresponding to executed job tests. The mobile tech application may also be used to transfer files between modular testing device 100 and email. Mobile device 304 is a smart phone that includes a camera and GPS. A technician may control the mobile device 304 to transfer GPS information and photographs to modular testing device 100 corresponding to a test. The job manager application on modular testing device 100 associates the GPS information and the photographs with a test, and stores the information in a corresponding summary report.

Server 306 runs centralized management software (CM) to provide centralized management of jobs executed by modular testing device 100, and other similarly configured modular testing devices. A service provider may manage thousands of similarly configured data centers and seek to ensure that all technicians servicing the data centers perform the same tests. According to an example, a service provider may deliver the same jobs, tests, and one button tests to modular testing devices in their fleet. According to an example, server 306 provides asset and data management, and delivers modular testing device assignments and software upgrades. Server 306 may distribute configurations and jobs to modular testing device 100, and serve as a central repository for test reports.

FIG. 3B illustrates a graphical user interface (GUI) 308 for modular testing device 100 having an automated test plan, according to examples of the present disclosure. Modular testing device 100 runs a job manager application, which is presented to a technician by job manager indication 310. According to an example, GUI 308 presents job manager 312, including customer name, job number, technician ID, and test location. According to an example, GUI 308 presents test plan 314, also known as a Job, indicating tests to be executed by modular testing device 100, and test status. According to the illustrated example, test plan 314 includes a fiber inspection test on cable 98765 for the fiber, a fiber inspection test on cable 98765 for the bulkhead, a CAA test at sector alpha, and a CPRI test at 700 MHz for radio alpha. According to an example, GUI 308 presents reports 316 of tests that have been previously executed by modular testing device 100 for review and comment by a technician. For example, a technician may add GPS and photographs to a test indicated in Reports 316.

According to an example, a technician is able to determine certain parameters and configurations of the modular testing device. According to an alternate example, certain parameters and configurations of the modular testing device may be predetermined.

A modular testing device may provide an option to initialize configurations with the last saved settings and the option to initialize configurations from a saved user profile. A modular testing device may provide an option to initialize configurations to factory defaults.

A modular testing device may also provide the ability to generate a report that records the configurations used for an automated test instance and includes the results analysis with the option to include pass/fail determinations and screenshots. A modular testing device may also provide the ability to navigate through the steps of configuring the test as well as view the test results in an intuitive user experience. A modular testing device may also provide a progress bar/overall test status widget that is always visible to give the user an indication of how the test is proceeding in time. A modular testing device may also provide a task selection screen from which a technician may invoke the automated test and have the ability to see a snapshot of the status of tasks scheduled to run as well as a means of navigating quickly to each task result screen.

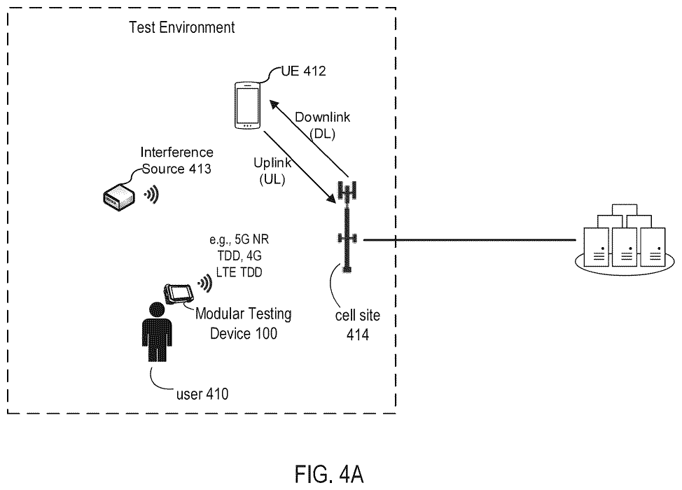

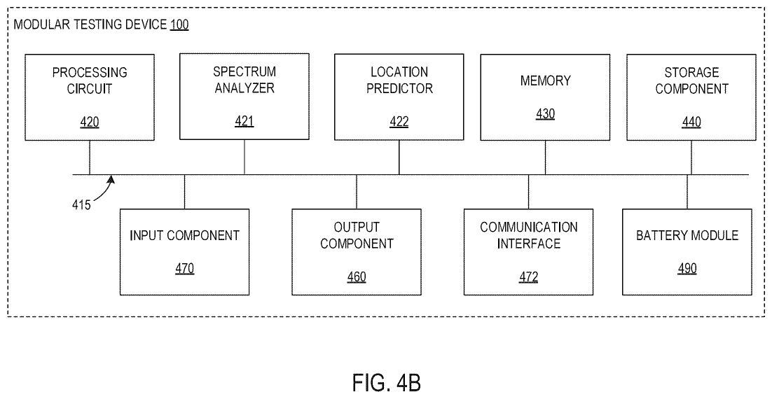

FIG. 4A illustrates a modular testing device operable to detect interference in a cellular service provider, according to examples of the present disclosure. 4G Long Term Evolution (LTE) Time Domain Duplex (TDD) and 5G New Radio (NR) TDD are examples of commonly used TDD technologies. The test environment may include cell site 414, which includes a cell tower or cellular base station having antennas and electronic communications equipment to support cellular mobile device communication in a TDD technology. The antennas and equipment are typically placed in connection with a radio mast or tower, and the equipment generally connects cell site air interfaces to wireline networks, which may be comprised of fiber optic cables and/or coaxial cables.

A customer of the cellular service provider may use user equipment (UE) 412 for communicating with the cell site 414 in the TDD technology. The communications include UL and DL transmissions supported by the cell site 414. UE 412 may be a smartphone or other wireless device. A user 410, such as a cellular service provider technician, may use the modular testing device 100 to perform the interference testing. In an example use case, the interference testing may be performed when the cell site is being installed, such as to ensure proper operation of the cell site with UE, such as smartphones or other end user cellular devices. In another example use case, after installation, customers of the cellular service provider may be experiencing degraded service, and the user 410 uses the modular testing device 100 to perform interference testing to detect and resolve interference that can be cause service issues.

In an example, an interference source 413 may be generating RF signals that interfere with the uplink or downlink communications of the UE 412. The modular testing device 100 may be used to detect the interference signals generated by the interference source 413, and may perform further analysis to determine a geographic location of the interference source 413 within the test environment. The test environment may be based on the cell size of the cell site 414.

FIG. 4B is a block diagram of the modular testing device 100, according to examples of the present disclosure. The modular testing device 100 may include a bus 415, a processing circuit 420, spectrum analyzer 421, location predictor 422, memory 430, a storage component 440, an input component 470, an output component 460, a communication interface 472, and battery module 490.

Bus 415 includes a component that permits communication among the components of modular testing device 100. Processing circuit 420 is implemented in hardware, firmware, or a combination of hardware and software. Processing circuit 420 may include one or more of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processing circuit 420 includes one or more processors capable of being programmed to perform a function. Memory 430 may include one or more memories such as a random access memory (RAM), a read only memory (ROM), and/or another type of dynamic or static storage device (e.g., a flash memory, a magnetic memory, and/or an optical memory) that stores information and/or instructions for use by processing circuit 420.

Spectrum analyzer 421 includes hardware and/or software as is known in the art for measuring and displaying the spectrum of a channel. Location predictor 422 estimates the location of the interference, e.g., the location of the interference source 13, if interference is detected during the transition period/guard period. The location predictor 422 may include machine readable instructions executed by a processor and/or other hardware. Estimation of location of the interference source 13 may be based on known geolocation techniques that can rely on RSS, PDOA and/or other parameters. Examples of the known geolocation techniques include: Angle of Arrival (AOA) which measures propagation direction of a signal (array antenna required); Time of Arrival (TOA)/Time Difference of Arrival (TDOA) which measures absolute time or time differences; Frequency Difference of Arrival (FDOA) which uses Doppler shift; and RSS)/PDOA, which measures and uses a path loss model. In an example, location predictor 422 may comprise the EagleEye software provided by Viavi™. Location predictor 422 may further include mapping software that provides visual and/or voice prompts to guide technicians to the suspected area of interference.

Storage component 440 stores information and/or software related to the operation and use of modular testing device 100. For example, storage component 440 may include a hard disk (e.g., a magnetic disk, solid state disk, etc.) and/or another type of non-transitory computer-readable medium.

Input component 470 includes a component that permits modular testing device 100 to receive information, such as via user input (e.g., a touch screen display, a keyboard, a keypad, a mouse, a button, a switch, and/or a microphone). Additionally, or alternatively, input component 470 may include a sensor for sensing information (e.g., a GPS component, an accelerometer, a gyroscope, and/or an actuator). Output component 460 includes a component that provides output information from modular testing device 100 (e.g., a display, a speaker, a user interface, and/or one or more light-emitting diodes (LEDs)). Output component 460 may include a display providing a graphical user interface (GUI), such as GUI. Input component 470 and output component 460 may be combined into a single component, such as a touch responsive display, also known as a touchscreen.

Communication interface 472 includes a transceiver-like component (e.g., a transceiver and/or a separate receiver and transmitter) that enables modular testing device 100 to communicate with other devices, such as via a wired connection, a wireless connection, or a combination of wired and wireless connections. Communication interface 472 may permit modular testing device 100 to receive information from another device and/or provide information to another device. For example, communication interface 472 may include an Ethernet interface, an optical interface, a coaxial interface, an infrared interface, an RF interface, a universal serial bus (USB) interface, a Wi-Fi interface, a cellular network interface, or the like.

Battery module 490 is connected along bus 415 to supply power to processing circuit 420, memory 430, and internal components of modular testing device 100. Battery module 490 may supply power during field measurements by modular testing device 100. Battery module 490 permits modular testing device 100 to be a portable.

Modular testing device 100 may perform one or more processes described herein. Modular testing device 100 may perform these processes by processing circuit 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices.

Software instructions may be read into memory 430 and/or storage component 440 from another computer-readable medium or from another device via communication interface 472. When executed, software instructions stored in memory 430 and/or storage component 440 may instruct processing circuit 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

In some examples, SA may be utilized to measure power and frequency for known and unknown signals. Also, in some examples, spectral masks and programmable phase noise analysis may be implemented to enable testing routines, such as persistence SA and interference analysis, and assess frequency utilization, interference, and accuracy of wireless transmission(s).

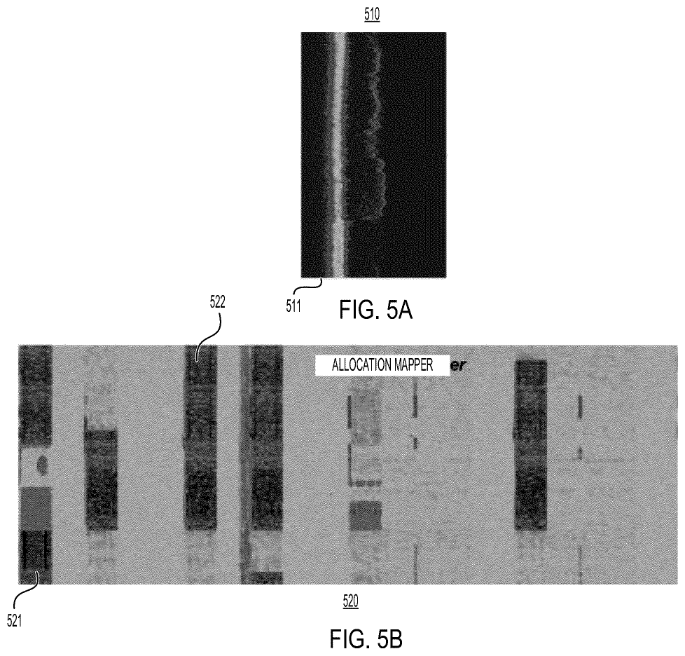

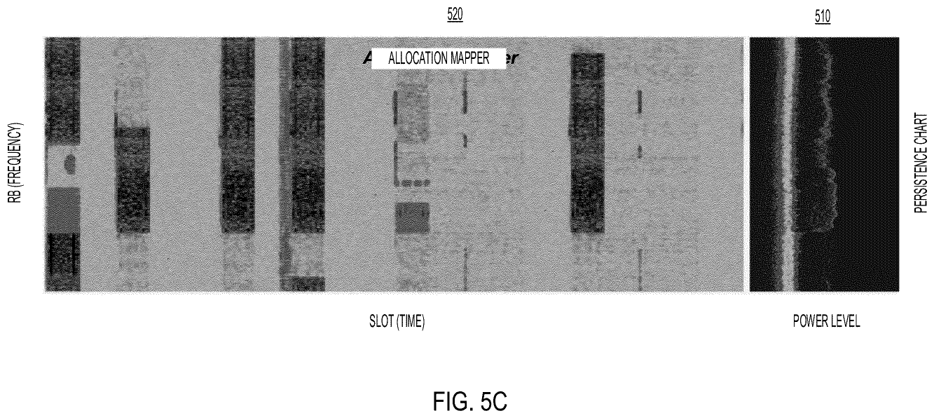

FIGS. 5A-5C illustrate various aspects of radio frequency (RF) signal analysis, according to examples of the present disclosure. FIG. 5A illustrates a chart 510 of a typical real-time spectrum, where the x-axis may provide frequency, the y-axis may provide power level, and color variations may indicated an occurrence frequency. In some examples, the chart 510 may illustrate an accumulation of a waveform, as may be measured and displayed by a modular testing device described herein. In some examples, the chart 510 may be displayed on a graphical user interface (GUI) of a display component, such as a display component of a modular testing device as described herein.

In some examples, the chart 510 may illustrate a power level 511 of a waveform with respect to a range of frequencies. Also, in some examples, the data illustrated in FIG. 5A may be gathered over a particular time period (or “sweep”). In some examples, a sweep time may be designated based on (or with respect to) a resolution bandwidth and span.

It may be appreciated that a modular testing device as described herein may enable additional functionalities as well. For example, in addition to SA, a modular testing device may determine an illustration of utilization according to one or more resource blocks (RB). As used herein, a “resource block” may, in some instances, be defined as a resource allocation unit to any user or element.

For example, FIG. 5B provides a chart 520 illustrating frequency mapping over a time span, with respect to one or more RBs. In some examples, the time span indicated in the chart 520 may be ten (10) to twenty (20) milliseconds (ms). In some instances, these time spans may also be interchangeably be referred to as time “slots. ” In some examples, the capture may be enabled (for example) by a Global Positioning System (GPS) trigger.

Accordingly, the chart 520 may, in some instances, constitute a “snapshot” of signal activity (e.g., associated with one or more RBs) as may be captured by a modular testing device, as described herein. In particular, in some instances, a modular testing device as described herein may provide the chart 520 to represent signal activity, such as orthogonal frequency-division multiplexing (OFDM) signals. Examples include long-term evolution (LTE) signals, NR signals, or Wi-Fi signals on a RB level.

In some examples, with regard to the chart 520, the x-axis may provide time and the y-axis may provide frequency. The bars 521, 522 may denote signal activity associated with RBs, and the chart 520 may also utilize colors (red, orange, yellow, etc.) to indicate allocated power level(s) (e.g., for data transmission) associated with the RBs.

FIG. 5C illustrates the chart 510 (from FIG. 5A) that may provide SA, and the chart 520 (from FIG. 5B) that may provide frequency (band) mapping over a time span with respect to one or more RBs, placed side-by-side so as to provide different aspects of the same RB activity. It may appreciated that, in some instances, it may be useful to capture additional data, beyond a single “snapshot” for analysis. Specifically, while a particular snapshot may provide RB information over a particular period of time (e.g., ten (10) to twenty (20) milliseconds (ms)), it may, in some instances, be beneficial to gather data over an extended period of time, and to analyze and compare the (additional) data to determine activity, or variation of activity, over the extended period of time.

Systems and methods described herein may provide various accumulation techniques in association with modular testing devices, as described herein. As used herein, “accumulation” may refer to, among other things, an aggregation or analysis of data captured by a modular testing device. So, in some examples, the systems and methods described herein may accumulate data associated with a plurality of capture events, such as a plurality of “snapshots” (e.g., as described above) that may be captured over an extended period of time (i.e., a period greater than that of each capture). By way of example, if each “snapshot” taken by a modular testing device may be over a span of ten (10) to twenty (20) milliseconds (ms), then the systems and methods provided herein may enable accumulation of a plurality of snapshots captured over a longer period of time (e.g., from one (1) to ten (10) seconds) for, among other things, analysis and comparison.

In some examples, accumulating captured data over longer periods may enable the systems and methods described herein to provide an “overlaying” of the captured snapshots. As used herein, “overlaying” may include any accumulation (e.g., gathering or combining), analysis, and/or associated display of data from a plurality of captured snapshots, wherein data from a first of snapshot and a data from one or more other snapshots may be accumulated, analyzed, and/or displayed with respect to each other.

By overlaying a plurality of captured snapshot data into one graphical representation (e.g., a chart), the systems and methods described herein may enable representation of periodicity along with various characteristics associated with (captured) signal activity. Indeed, and in particular, by combining and overlaying data from a plurality of snapshots, the systems and methods described herein may enable additional analysis of signal activity than that may not be available or possible with a single snapshot.

Furthermore, the systems and methods described herein may provide multi-functional mapping functionalities that may be directed to a plurality of signals (e.g., captured over a plurality of time slots). The systems and methods described herein may provide cumulative time and interval controlling functionalities for said accumulated capture, and may display the captured data on a display component (e.g., such as found on a modular testing device) to enable visual analysis of signal activity. Furthermore, as will be discussed in greater detail below, the systems and methods described herein may be directed to detection of various signal types, including (but not limited to) known, unknown, delayed, “fast,” and/or “periodic” signal types.

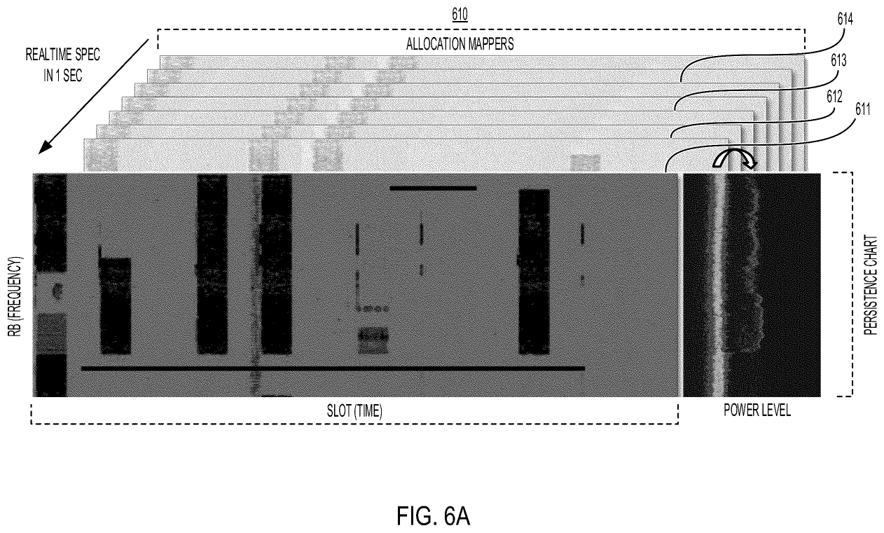

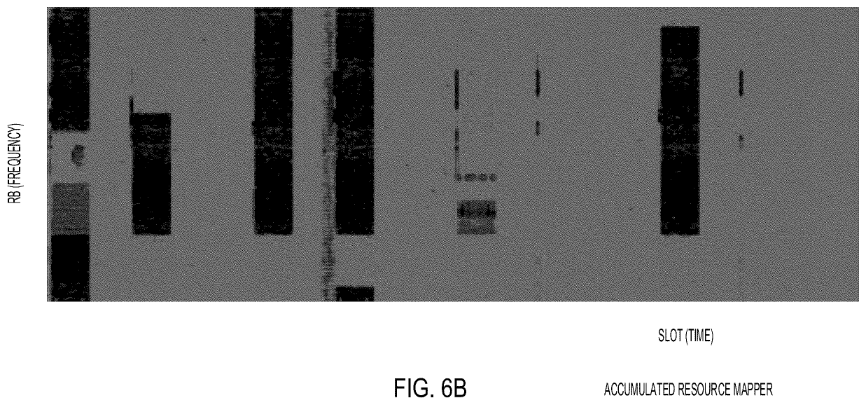

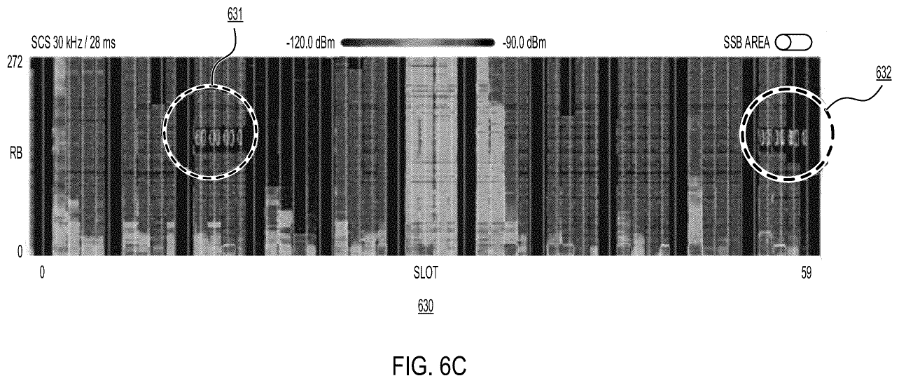

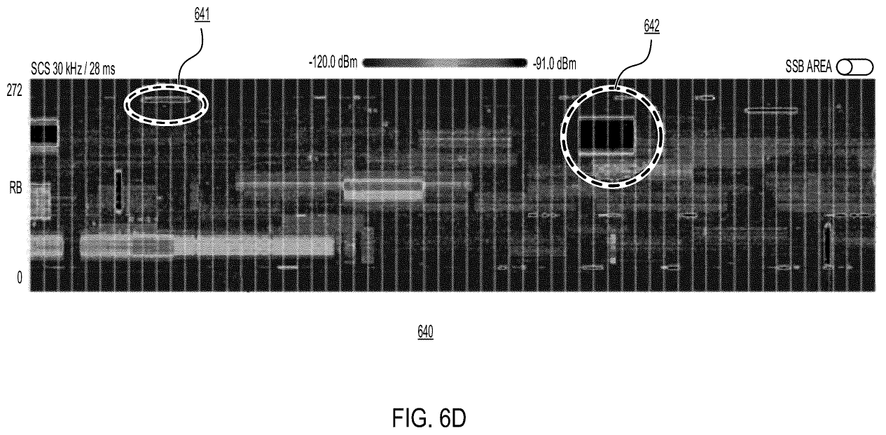

FIGS. 6A-6D illustrate various aspects of radio frequency (RF) signal analysis via accumulation, according to examples of the present disclosure. FIG. 6A illustrates an accumulation of various snapshots (e.g., as gathered by a modular testing device), according to examples described herein. In some examples, a modular testing device (e.g., modular testing device 100) may capture a plurality of snapshots 610, wherein each snapshot 611, 612, 613, 614 may be gathered over a first predetermined period of time (e.g., ten (10) to twenty (20) milliseconds (ms)). In some examples, this first predetermined period of time may be referred to as a “capture period.”

In some examples, over a second predetermined period of time (e.g., one (1) to ten (10) seconds), a plurality of snapshot (captures) may be taken by the modular testing device. In some examples this second predetermined period of time may be referred to as an “accumulation period.”

In some examples, a modular testing device as described herein may capture the plurality of snapshots, and may accumulate (combine) and/or analyze the data associated with the plurality of snapshots. As a result, systems and methods described herein may be configured to provide an accumulated (or combined) resource block allocation for a particular (e.g., predetermined) period of time.

In some examples, the captured, accumulated data may then be sorted and analyzed. For example, in some instances, each of the plurality of snapshots may be overlaid on top of each other (e.g., in a sequential fashion) to provide a cumulative (e.g., visual) representation. In some examples, the accumulated and/or analyzed data may be gathered for display on a display screen of the modular testing device as well. In some examples, the cumulative representation may take the form of a single, combined graphical representation for display.

FIG. 6B illustrates a graphical representation 620 of a plurality of snapshots overlaid to provide a cumulative representation. In some examples, the captured, accumulated data from the cumulative representation may then be sorted and analyzed. In some examples, one or more of the capture, sorting, and analysis may be done according to predetermined user settings (e.g., as may be set by a service technician). Examples of these predetermined user settings may include capture periods, accumulation periods, and signal activity analysis.

In some examples, captured signal activity may be analyzed to detect various signal types. Examples of these various signal types may include, but are not limited to, known (or anticipated) signals, unknown signals, fast or fast-passing signals, periodic signals, and/or aperiodic signals. As used herein, a “periodic” signal may include a signal that may repeat according to a particular time period. An “aperiodic” signal may include a signal that may appear randomly, or may not repeat according to any particular time period. Also, as used herein, a “fast” or “fast-passing” signal may include signals that may be signals that may be captured or may appear for such a short period of time (e.g., due to visual display performance limitations) that it may make detection difficult.

In some examples and in this manner, a cumulative signal activity for each of a plurality of resource blocks may be determined and displayed. Specifically, in some examples, the cumulative signal activity may include data associated with each (available) signal and/or signal type, which may then be represented uniquely in an (identifiable) graphical representation. By way of example, an orthogonal frequency domain modulation (OFDM) “sync” signal, or a single-sideband modulation (SSB) signal may each have shapes that may be detected, for example, visually in a graphical representation. Accordingly, in this manner, the systems and methods described herein may enable checking of a status and usage of a frequency band of interest.

FIG. 6C illustrates a graphical representation 630 of a snapshot indicating a signal type. In this example, a (repeating) periodicity of a NR SSB signal may indicated at multiple locations 631, 632 of the graphical representation 630. So, in some examples, these locational indications and/or signal characteristics may be analyzed to determine or verify a signal type or signal characteristic.

FIG. 6D illustrates a graphical representation 640 of a snapshot indicating a signal type. In this example, a first signal type 641 (e.g., Bluetooth) and a second signal type 642 (e.g., Wi-Fi) may be analyzed and indicated on the graphical representation 640. It may be appreciated that, in some examples, the graphical representations 630, 640 may be overlaid and combined into one graphical representation (as described herein).

Furthermore, the systems and methods described herein may enable signal analysis through “playback” over (captured) time periods, wherein data associated with captured time periods may be collected, displayed, and/or analyzed to determine various aspects of signal activity. So, in one example, data associated with a time period of interest (e.g., when an anomaly may have occurred in a time span associated with two particular snapshots or time slots) may be collected, and associated snapshots may be played back (i.e., displayed and played back in a continuous manner), analyzed (e.g., by the modular testing device) and reviewed (e.g., visually by a service technician) to analyze and identify a signal characteristic (e.g., known, unknown, fast, delayed, etc.) and/or determine an associated event or anomaly that may have occurred.

Accordingly, in some examples, the systems and methods described herein may enable quick and efficient detection of unknown and/or unwanted signal activity. Specifically, in some examples, the data from an accumulation may be analyzed in RB perspective as opposed to waveform perspective (e.g., as in real-time spectrum analysis), and therefore may enable the quick and efficient determination of the unknown and/or unwanted signal activity, and further may be used to troubleshoot in a signal activity in one or more radio frequency (RF) environments. So, in some examples, the data from an accumulation may be analyzed to detect unknown or suspicious signals and address and/or eliminate them. For example, AI and/or ML techniques may be utilized to detect, among other things, illegal signals, control or military (e.g., drone signals) signals, or detecting hidden camera signals as well. Additionally, in some examples, the system and methods described herein may implement various artificial intelligence (AI) and machine learning (ML)-based model signal analysis techniques to detect unknown and/or unwanted signal activity as well.

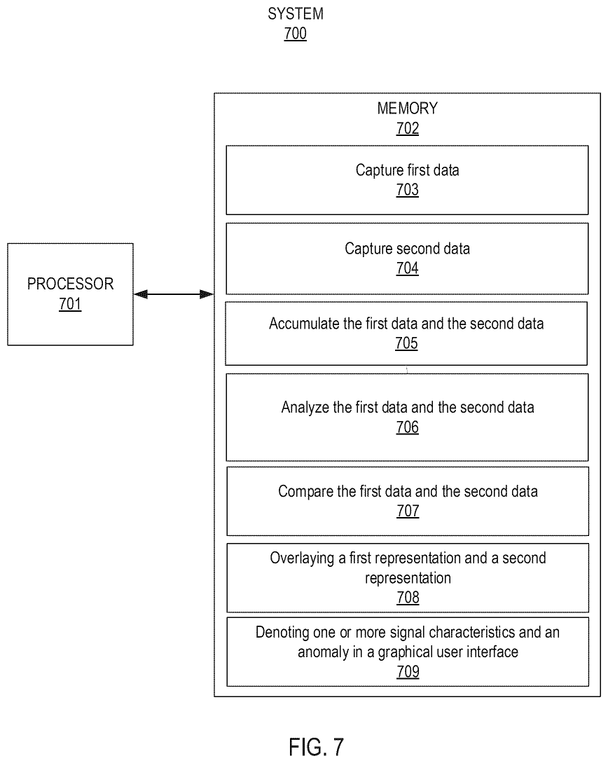

Reference is now made to FIG. 7. FIG. 7 illustrates a block diagram of a system that may be implemented to use signal analysis techniques to determine signal characteristics and transmission anomalies in telecommunications systems, according to examples of the present disclosure.

As shown in FIG. 7, the system 700 may include processor 701 and the memory 702. In some examples, the processor 701 may be configured to execute the machine-readable instructions stored in the memory 702. It should be appreciated that the processor 701 may be a semiconductor-based microprocessor, a central processing unit (CPU), an application specific integrated circuit (ASIC), a field-programmable gate array (FPGA), and/or other suitable hardware device.

In some examples, the memory 702 may have stored thereon machine-readable instructions (which may also be termed computer-readable instructions) that the processor 701 may execute. The memory 702 may be an electronic, magnetic, optical, or other physical storage device that contains or stores executable instructions. The memory 702 may be, for example, random access memory (RAM), an Electrically Erasable Programmable Read-Only Memory (EEPROM), a storage device, an optical disc, or the like. The memory 702, which may also be referred to as a computer-readable storage medium, may be a non-transitory machine-readable storage medium, where the term “non-transitory” does not encompass transitory propagating signals.

In some examples, the instructions 703 may capture first data associated with signal activity of one or more resource blocks (RB) a communications link for a first capture period.

In some examples, the instructions 704 may capture second data associated with signal activity of the one or more RBs of the communications link for one or more additional capture periods, wherein the plurality of additional time spans temporally follow the first capture periods.

In some examples, the instructions 705 may accumulate the first data and the second data, as described above. In some examples, this may include combining the first data and the second data and preparing (e.g., formatting, contextualizing, applying user settings, etc.) the first and second data for analysis.

In some examples, the instructions 706 may analyze the first data and the second data to determine one or more signal characteristics.

In some examples, the instructions 707 may compare the first data and the second data to determine an anomaly.

In some examples, the instructions 708 may overlay a first representation of the first data and a second representation of the second data to display an overlay representation on a graphical user interface (GUI) of a display component.

In some examples, the instructions 709 may denote at least one of the one or more signal characteristics and the anomaly in the graphical user interface.

Additionally, and as described above, although not depicted, instructions 703-709 may be configured to utilize various artificial intelligence (AI) and machine learning (ML) based tools. For instance, these artificial intelligence (AI) and machine learning (ML) based tools may be used to analyze signal activity as described herein, in a manner that may include implementation of a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 700 may provide other types of machine learning (ML) approaches as well, such as reinforcement learning, feature learning, anomaly detection, etc.

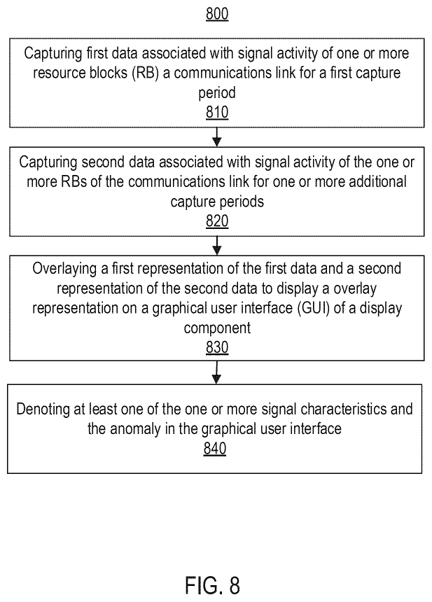

FIG. 8 illustrates a method for using signal analysis techniques for determining signal characteristics and transmission anomalies in telecommunications systems, according to examples of the present disclosure. The method 800 is provided by way of example, as there may be a variety of ways to carry out the method described herein. Each block shown in FIG. 8 may further represent one or more processes, methods, or subroutines, and one or more of the blocks may include machine-readable instructions stored on a non-transitory computer-readable medium and executed by a processor or other type of processing circuit to perform one or more operations described herein. In some examples, the method 800 may be executed or otherwise performed by other systems, or a combination of systems.

Reference is now made with respect to FIG. 8. At 810, the method may include capturing first data associated with signal activity of one or more resource blocks (RB) a communications link for a first capture period.

At 820, the method may include capturing second data associated with signal activity of the one or more RBs of the communications link for one or more additional capture periods, wherein the plurality of additional time spans temporally follow the first capture periods.

At 830, the method may include overlaying a first representation of the first data and a second representation of the second data to display an overlay representation on a graphical user interface (GUI) of a display component.

At 840, the method may include denoting at least one of the one or more signal characteristics and the anomaly in the graphical user interface.

In some examples, the systems and methods described herein may include a testing device for testing conditions associated with a data center, comprising an input/output (I/O) device comprising a display, a processor, a memory to store machine readable instructions executable by the processor to capture first data associated with signal activity of one or more resource blocks (RB) of a communications link for a first capture period, capture second data associated with signal activity of the one or more RBs of the communications link for one or more additional capture periods, wherein the one or more additional capture periods temporally follow the first capture period, analyze the first data and the second data to determine one or more signal characteristics. Also, in some examples, the instructions may be executable to compare the first data and the second data to determine an anomaly, overlay a first representation of the first data and a second representation of the second data to display a overlay representation on a graphical user interface (GUI) of a display component, and denote at least one of the one or more signal characteristics and the anomaly in the graphical user interface. In some examples, the first representation of the first data and the second representation of the second data are played back to enable determination of the anomaly, the overlay representation displays each detected signal uniquely via an identifiable graphical representation, and the first capture period and the one or more additional capture periods are predetermined periods of time. Also, in some examples, the first capture period and the one or more additional capture periods are between ten (10) to twenty (20) milliseconds (ms), the first capture period and the one or more additional capture periods take occur over a predetermined accumulation period, and the predetermined accumulation period is between one (1) to ten (10) seconds. In addition, analyzing the one or more signal characteristics may include designation of one or more signal types, and the one or more signal types includes known, unknown, delayed, fast, and periodic.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims-and their equivalents-in which all terms are meant in their broadest reasonable sense unless otherwise indicated.

What is claimed is:

1. A testing device for testing conditions associated with a communications link, comprising:
an input/output (I/O) device comprising a display;
a processor;
a memory to store machine readable instructions executable by the processor to:
capture first data associated with signal activity of one or more resource blocks (RB) of the communications link for a first capture period;
capture second data associated with signal activity of the one or more RBs of the communications link for one or more additional capture periods, wherein the one or more additional capture periods temporally follow the first capture period;
analyze the first data and the second data to determine one or more signal characteristics, wherein the one or more signal characteristics include designation of one or more signal types;
overlay a first representation of the first data and a second representation of the second data to display a overlay representation on a graphical user interface (GUI) of a display component; and
denote at least one of the one or more signal characteristics in the graphical user interface.

2. The testing device according to claim 1, wherein the memory stores machine readable instructions further executable by the processor to compare the first data and the second data to determine an anomaly.

3. The testing device according to claim 2, wherein the memory stores machine readable instructions further executable by the processor to denote the anomaly in the graphical user interface.

4. The testing device according to claim 2, wherein the first representation of the first data and the second representation of the second data are played back to enable determination of the anomaly.

5. The testing device according to claim 1, wherein the overlay representation displays each detected signal uniquely via an identifiable graphical representation, and wherein the one or more signal types include known, unknown, delayed, fast, and periodic.

6. The testing device according to claim 1, wherein the first capture period and the one or more additional capture periods are predetermined periods of time.

7. The testing device according to claim 1, wherein the first capture period and the one or more additional capture periods are between ten (10) to twenty (20) milliseconds (ms).

8. The testing device according to claim 1, wherein the first capture period and the one or more additional capture periods take occur over an predetermined accumulation period.

9. The testing device according to claim 8, wherein the predetermined accumulation period is between one (1) to ten (10) seconds.

10. A method for using signal analysis techniques for determining signal characteristics and transmission anomalies in telecommunications systems, the method comprising:
capturing first data associated with signal activity of one or more resource blocks (RB) of a communications link for a first capture period;
capturing second data associated with signal activity of the one or more RBs of the communications link for one or more additional capture periods, wherein the one or more additional capture periods temporally follow the first capture period;
accumulating the first data and the second data;
analyzing the first data and the second data to determine one or more signal characteristics, including designating of one or more signal types, wherein the one or more signal types includes known, unknown, delayed, fast, and periodic;
overlaying a first representation of the first data and a second representation of the second data to display a overlay representation on a graphical user interface (GUI) of a display component; and
denoting at least one of the one or more signal characteristics in the graphical user interface.

11. The method of claim 10, further comprising displaying each detected signal uniquely on the overlay representation via an identifiable graphical representation.

12. The method of claim 10, wherein the first capture period and the one or more additional capture periods are between ten (10) to twenty (20) milliseconds (ms).

13. The method of claim 10, wherein the first capture period and the one or more additional capture periods take occur over a predetermined accumulation period, and wherein the predetermined accumulation period is between one (1) to ten (10) seconds.

14. The method of claim 10, further comprising comparing the first data and the second data to determine an anomaly.

15. The method of claim 14, further comprising denoting the anomaly in the graphical user interface.

16. A modular testing device comprising:
a processor to determine test results for a plurality of tests performed by the modular testing device;
a plurality of interfaces connecting a base module to a plurality of modules connected to the base module; and
a memory storing computer-executable instructions, which when executed by the processor, cause the processor to:
capture first data associated with signal activity of one or more resource blocks (RB) of a communications link for a first capture period;
capture second data associated with signal activity of the one or more RBs of the communications link for one or more additional capture periods, wherein the one or more additional capture periods temporally follow the first capture period;
accumulate the first data and the second data;
analyze the first data and the second data to determine one or more signal characteristics, including designating of one or more signal types, wherein the one or more signal types includes known, unknown, delayed, fast, and periodic;
compare the first data and the second data to determine an anomaly;
overlay a first representation of the first data and a second representation of the second data to display a overlay representation on a graphical user interface (GUI) of a display component; and
denote at least one of the one or more signal characteristics and the anomaly in the graphical user interface.

17. The modular testing device of claim 16, wherein the first representation of the first data and the second representation of the second data are played back to enable determination of the anomaly.

18. The modular testing device of claim 16, wherein the overlay representation displays each detected signal uniquely via an identifiable graphical representation.

19. The modular testing device of claim 16, wherein the first capture period and the one or more additional capture periods are between ten (10) to twenty (20) milliseconds (ms).

20. The modular testing device of claim 16, wherein the first capture period and the one or more additional capture periods take occur over an predetermined accumulation period, and wherein the predetermined accumulation period is between one (1) to ten (10) seconds.
